(19) United States
(12) Patent Application Publication
(10) Pub. No.: US 2019/0197089 A1
(43) Pub. Date: Jun. 27, 2019

(54) Harnessing Analytics By Server To Increase Interactivity Of Visitor with Customer's Application

(71) Applicant: Zmags Corp., Boston, MA (US)

(72) Inventors: Lindsay Raye Moore, Wake Forest, NC (US); Caitlin Porte Sullivan, Boston, MA (US)

(21) Appl. No.: 16/227,891

(22) Filed: Dec. 20, 2018

Related U.S. Application Data
(60) Provisional application No. 62/609,788, filed on Dec. 22, 2017.

(51) Int. Cl. G06F 17/22; H04L 29/08; G06Q 30/02

(52) U.S. Cl. CPC G06F 17/2288; H04L 67/2823; H04L 67/42; G06Q 30/0269; G06F 17/2247

(57) ABSTRACT

The current subject matter relates to a computing server that can: (a) transmit, to a client computer, data to execute a program that enables a customer authorized to use the client computer to create multimedia assets, (b) receive multimedia assets from the client computer and store them, (c) publish, based on attributes specified by the user or pre-stored attributes, the multimedia assets on an application (e.g., website) executed on computing devices of visitors, (d) analyze the interaction between the visitors and the multimedia assets as well as between the visitors and the attributes of the displayed multimedia assets to generate an analysis, and (e) modify the multimedia assets in the application in real-time based on at least one of the analysis and one or more preferences of the customer. The application with the modified assets can be more engaging and interactive for visitors of the application.

### RELATED APPLICATION

This disclosure claims priority to U.S. provisional patent application Ser. No. 62/609,788, entitled “HARNESSING ANALYTICS BY SERVER TO INCREASE INTERACTIVITY OF VISITOR WITH CUSTOMER'S APPLICATION” and filed on Dec. 22, 2017, the entire contents of which are incorporated herein by reference in entirety.

### TECHNICAL FIELD

The subject matter described herein relates to a computing server that can: (a) transmit, to a client computer, data to execute a program that enables a customer authorized to use the client computer to create multimedia assets, (b) receive multimedia assets from the client computer and store them, (c) publish, based on attributes specified by the user or pre-stored attributes, the multimedia assets on an application (e.g., website) executed on computing devices of visitors, (d) analyze the interaction between the visitors and the multimedia assets as well as between the visitors and the attributes of the displayed multimedia assets to generate an analysis, and (e) modify the multimedia assets in the application in real-time based on at least one of the analysis and one or more preferences of the customer.

### BACKGROUND

Retailers often have simple websites that display multimedia for products being offered for sale. The displayed multimedia on a website stays the same regardless of the interaction of the website with visitors of the website (e.g., shoppers). The stagnation of the displayed multimedia without any intelligence prevents any improvement of interactivity and engagement between the website and those visitors. There thus exists a need to generate an analysis of the displayed multimedia to enhance the multimedia so as to make the website more engaging and interactive, which can translate directly to increased visitor interest and loyalty (e.g., repeat shoppers) and therefore increased revenue for the retailers.

### SUMMARY

A computing server is described that can: (a) transmit, to a client computer, data to execute a program that enables a customer authorized to use the client computer to create multimedia assets, such as images, video, action-based icons, text, any combination thereof, and/or the like, (b) receive multimedia assets from the client computer and store them, (c) publish, based on attributes—e.g., identification of object shown in images, type of animation in the action-based items, number of images, page size of the multimedia asset, font type, font size, font color, any combination thereof, and/or the like—specified by the user or pre-stored attributes, the multimedia assets on an application (e.g., website) executed on computing devices configured to be used by visitors, (d) analyze the interaction between the visitors and the multimedia assets as well as between the visitors and the attributes of the displayed multimedia assets to generate an analysis, and (e) modify the multimedia assets in the application in real-time based on at least one of the analysis and one or more preferences of the customer. The application with the modified assets can be more engaging and interactive for visitors of the application.

A computing server can display a multimedia asset—e.g., images, video, action-based icons, text, any combination thereof, and/or the like—on an application (e.g., website) of a customer. The computing server can analyze attributes—e.g., identification of object shown in images, type of animation in the action-based items, number of images, page size of the multimedia asset, font type, font size, font color, any combination thereof, and/or the like—of the multimedia asset to generate an analysis. The computing server can receive customer preferences for display of multimedia assets on the application. The computing server can generate new multimedia assets or identify preexisting multimedia assets based on the analysis and the customer preferences. The computing server can insert the new multimedia assets or retain the identified preexisting multimedia assets in the application to make the application more engaging and interactive.

In one aspect, a computing server can transmit, to a client computer, data to execute a computer program that interacts with a customer authorized to use the client computer to create one or more multimedia assets. The computing server can receive, from the client computer, the one or more multimedia assets. The computing server can publish, based on at least one attribute of the one or more multimedia assets, the one or more multimedia assets on an application executed on one or more computing devices communicatively coupled to the computing server. The computing server can analyze one or more interactions between the one or more computing devices and the one or more published multimedia assets and between the one or more computing devices and the at least one attribute of the one or more published multimedia assets to generate an analysis. The computing server can modify the one or more published multimedia assets in the application based on at least one of the analysis and one or more preferences of the customer.

In some variations, one or more of the following can be implemented either individually or in any suitable/feasible combination. The one or more multimedia assets can include at least one of an image, a video, an action-based icon, and text. The at least one attribute of the one or more multimedia assets can include one or more of: an identification of a multimedia asset of the one or more multimedia assets, a type of animation in the multimedia asset, a number of images in the multimedia asset, a page size of the multimedia asset, a font type for the multimedia asset, a font size for the multimedia asset, and a font color for the multimedia asset. The type of animation can include one or more of: a hover-over effect associated with multimedia asset, a fade-in effect associated with multimedia asset, a transparency change associated with multimedia asset, and an image enlargement associated with multimedia asset.

The application executed on one or more computing devices can be communicatively coupled to the computing server via a content delivery network comprising one or more proxy servers. The analysis can include one or more of: an image metric associated with a multimedia asset of the one or more multimedia assets, an attribute metric associated with the multimedia asset, and an experience metric associated with the multimedia asset. The publishing of the multimedia assets on the application can include overlaying the multimedia assets on the application. The computing server can further store the multimedia assets received from the client computer.

The application can be a website. The one or more computing devices can be configured to be operated by one or more visitors of the application. The modifying of the one or more published multimedia assets in the application can occur in real-time.

In another aspect, a system is described that can include a user interface module, an application programming interface, and a web module. The user interface module can provide a computer program to a client computer. The application programming interface can receive an identification of one or more multimedia assets and one or more customer preferences from the client computer. The web module can transmit the one or more multimedia assets to a content delivery network for publication in an application implemented on a computing device. The content delivery network can be configured to be communicatively coupled to the web module and the computing device.

In some variations, one or more of the following can be implemented either individually or in any suitable/feasible combination. The system can further include a database to receive the one or more multimedia assets from the web module. The database can be configured to store the received one or more multimedia assets. The system can further include a controller operably coupled to the user interface module, the application programming interface, and the web module. The web module can be configured to receive the identification of one or more multimedia assets and the one or more customer preferences from the application programming interface.

In yet another aspect, a non-transitory machine-readable medium is described that can store instructions that, when executed by at least one programmable processor, cause the at least one programmable processor to perform operations including: transmitting, to a client computer, data to execute a program that enables a customer authorized to use the client computer to create one or more multimedia assets; receiving, from the client computer, the one or more multimedia assets; publishing, based on at least one attribute of the one or more multimedia assets, the one or more multimedia assets on an application executed on one or more computing devices coupled to the computing server; analyzing one or more interactions between the one or more computing devices and the one or more published multimedia assets and between the one or more computing devices and the at least one attribute of the one or more published multimedia assets to generate an analysis; and/or modifying the one or more published multimedia assets in the application based on the analysis.

In some variations, one or more of the following can be implemented either individually or in any suitable/feasible combination. The publishing of the multimedia assets on the application can include overlaying the multimedia assets on the application. The operations can further include storing, by the computing server, the multimedia assets received from the client computer. The application can be a website. The one or more computing devices can be configured to be operated by one or more visitors of the website. The modifying of the one or more published multimedia assets in the application occurs in real-time.

The subject matter described herein provides many advantages. For example, the implementations described herein can make an application (e.g., website) of a customer (e.g., retailer) more engaging and interactive while also helping the retailer understand why a multimedia asset (e.g., at least one of images, video, action-based icons, text, any combination thereof, and the like) is effective.

The details of one or more variations of the subject matter described herein are set forth in the accompanying drawings and the description below. Other features and advantages of the subject matter described herein will be apparent from the description, the drawings, and the claims.

### DESCRIPTION OF DRAWINGS

FIG. 1 illustrates a system that includes a computing server that can: (a) transmit, to a client computer, data to execute a program that enables a customer authorized to use the client computer to create multimedia assets, (b) receive multimedia assets from the client computer and store them, (c) publish, based on attributes specified by the user or pre-stored attributes, the multimedia assets on an application (e.g., website) executed on computing devices of visitors, (d) analyze the interaction between the visitors and between the visitors and the multimedia assets as well as the attributes of the displayed multimedia assets to generate an analysis, and (e) modify the multimedia assets in the application in real-time based on at least one of the analysis and one or more preferences of the customer;

FIG. 2 illustrates storage of multimedia assets in one or more databases of the computer server, tagging each stored multimedia asset with corresponding attributes, and enabling a search of the stored assets based on specific one or more attributes;

FIG. 3 illustrates storing multimedia assets, analyzing them with various metrics, and sending to a client computer a selective portion of the analysis upon request for the same by the client computer;

FIG. 4 illustrates creation, storage, and analysis of new multimedia assets in real-time; and

FIG. 5 illustrates a real-time population of an effective multimedia asset onto the application based on values of metrics and preferences specified by the customer on the client computer.

When practical, like reference symbols in the various drawings indicate like elements.

### DETAILED DESCRIPTION

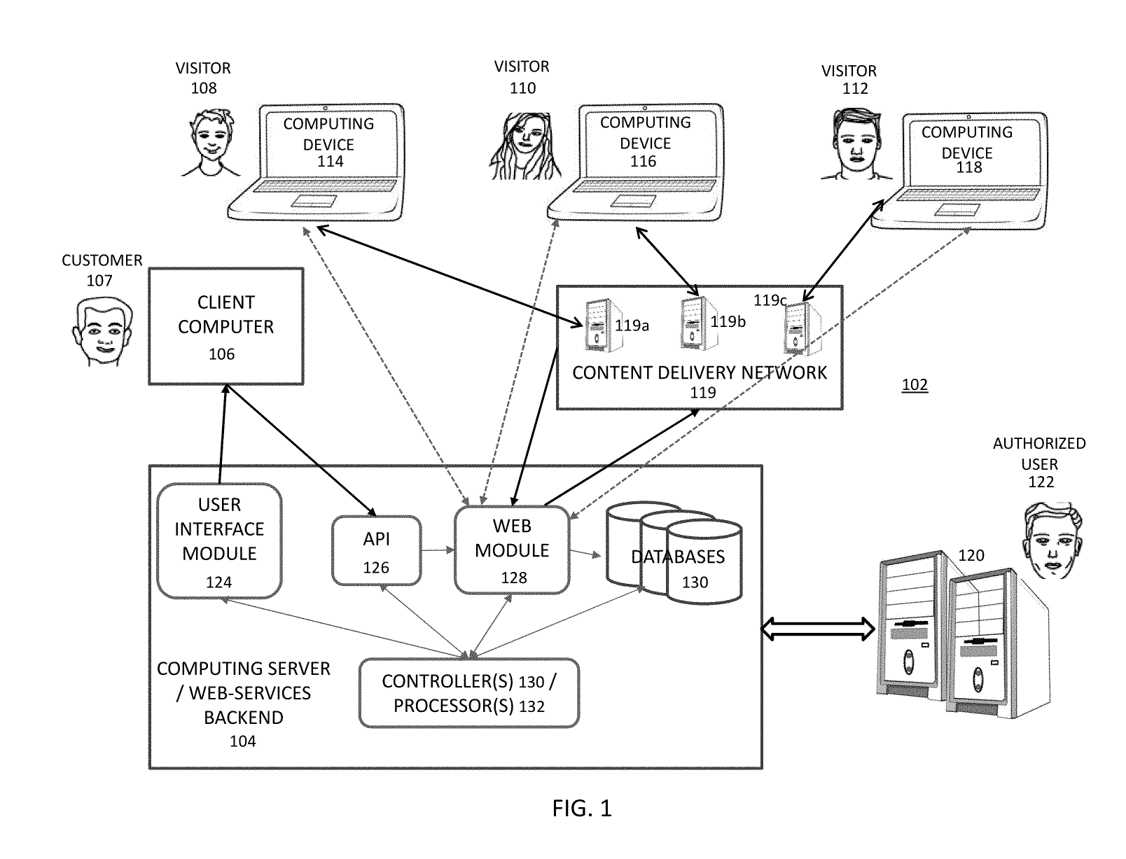

FIG. 1 illustrates a system 102 that includes a computing server 104 that can: (a) transmit, to a client computer 106, data to execute a program that enables a customer 107 authorized to use the client computer 106 to create multimedia assets, (b) receive multimedia assets from the client computer 106 and store them, (c) publish (e.g., overlay), based on attributes specified by the user or pre-stored attributes, the multimedia assets on an application (e.g., website) to be used by visitors 108, 110 and 112 and on computing devices 114, 116, and 118, (d) analyze the interaction between the visitors 108, 110 and 112 and the multimedia assets as well as between the visitors 108, 110 and 112 and the attributes of the displayed multimedia assets to generate an analysis, and (e) modify—dynamically in some implementations, and statically in alternate implementations—the multimedia assets in the application based on at least one of the analysis and one or more preferences of the customer 107. The application with the modified assets can be more engaging and interactive for visitors 108, 110, and 112 of the application. The computing server 104 can also be referred to as a web-services backend.

The computing server 104 can transmit data (e.g., some or all data) related to the application to the computing devices 114, 116 and 118 via a content delivery network 119, which can include distributed (e.g., geographically distributed) proxy servers 119a, 119b, 119c, and so on. The computing server 104 can receive the interaction data from the computing devices 114, 116 and 118 via the content delivery network 119. In an alternate implementation, the computing server 104 can transmit the data related to the application directly to the computing devices 114, 116, and 118, and/or can receive the interaction data directly from the computing devices 114, 116 and 118, as shown using dotted lines.

The multimedia asset can be at least one of images, video, action-based icons, text, any combination thereof, and the like. The attributes of the multimedia asset can include at least one of identification of object shown in images, type of animation in the action-based items, number of images, page size of the multimedia asset, font type, font size, font color, any combination thereof, and the like. Examples of animation can include hover-over effects, fade-in effect, transparency changes, image enlargement, and the like.

The analysis can include metrics, such as: (1) image metrics, such as size of image, location of image within an experience, number of actions associated with an image, conversion rate of an image (where applicable), views of an image, number of clicks on an image, click rate on an image, and engagement metrics; (2) attribute metrics, such as number of attributes; type of attributes used; conversion rate of assets with a particular attribute or set of attributes; conversions on assets with a particular attribute or set of attributes; clicks of assets with a particular attribute or set of attributes; and click rate of assets with a particular attribute or set of attributes; (3) experience metrics, such as location of sub assets (for example, images, animations, or any combination thereof) within an experience, size such as height and width as well as location on the webpage, status of each experience associated with an asset, views, clicks, click rate, conversions, conversion rate, engagement; and/or any other metric.

Examples of clicks described herein can include the number of times a visitor 108, 110 or 112 initiates an action with a multimedia asset, such as touching a buy button on a touch screen or selecting a button with a mouse. The click rate can be the percentage of visitors 108, 110 and 112 of the application that initiates an action with a multimedia asset as opposed to merely viewing the asset. The conversion rate can be the percentage of visitors 108, 110 and 112 who purchase a product or service offered on the application. Conversions can be the number of visitors 108, 110 and/or 112 who purchase a product or service offered on the application. Views of a particular multimedia asset can be the number of times that any combination of multimedia assets including that particular multimedia asset is seen by the visitors 108, 110 and/or 112. View rate of a particular multimedia asset can be the percentage of times that particular multimedia asset is seen by the visitors 108, 110 and/or 112.

The computing server 104 can be controlled by one or more servers 120 configured to be operated by an authorized user 122.

The computing server 104 can include a user interface module 124, one or more application programming interfaces (API) 126, one or more web modules 128, one or more databases 130, and one or more controllers 132 having one or more processors 134.

The user interface module 124 can provide the computer program to the client computer 106 that allows the customer 107 to create multimedia assets, input preferences, and/or communicate with the computing server 104 via a communication network. This communication network can be either a wired connection, or a wireless network that can be one or more of: a local area network, a wide area network, a metropolitan area network, internet, intranet, Bluetooth network, infrared network, and other communication networks. The API 126 can receive data—such as selection of multimedia assets, customer preferences, and other data—from the client computer 128. The API 128 can enable the controller 132 and the web module 128 to communicate with the client computer 106. The web modules 128 can publish the multimedia assets in the application and transmit content to the computing devices 114, 116 and 118 directly and/or via the content delivery network 119. The computing server 104 can be connected to the content delivery network via a communication network, which can be either a wired connection, or a wireless network that can be one or more of: a local area network, a wide area network, a metropolitan area network, internet, intranet, Bluetooth network, infrared network, and other communication networks. The databases 130 can store data within (e.g., any data received or generated by) the computing server 124.

In some implementations, any arrow shown in the drawing can be either a wired connection, or a wireless network that can be one or more of: a local area network, a wide area network, a metropolitan area network, internet, intranet, Bluetooth network, infrared network, and other communication networks. All the components shown within the cloud computing server 104 may be enclosed together within a single housing. In an alternate implementation, some or all of the components of the cloud computing server 104 may be enclosed in separate housings.

The computing server 104 can be a cloud computing server that can be controlled by one or more servers 120 via a querying language, such as structured query language (SQL). The computing server 104 can be communicatively coupled to the one or more servers 120 via a communication network, which can be either a wired connection, or a wireless network that can be one or more of: a local area network, a wide area network, a metropolitan area network, internet, intranet, Bluetooth network, infrared network, and other communication networks.

The client computer 106 can be in a client-server relationship with the computing server 104. The client computer 106 can be at least one of: a desktop computer, a laptop computer, a tablet computer, a phablet computer, a cellular phone, and other computing devices. The client computer 106 can be communicatively coupled with the computing server 104 via a communication network, which can be one or more of: a local area network, a wide area network, a metropolitan area network, internet, intranet, Bluetooth network, infrared network, and other communication networks.

Each of the computing devices 114, 116 and 118 can at least one of: a desktop computer, a laptop computer, a tablet computer, a phablet computer, a cellular phone, and other computing devices. Each of the computing devices 114, 116 and 118 can be communicatively coupled with the client computing server 106 via a communication network, which can be one or more of: a local area network, a wide area network, a metropolitan area network, internet, intranet, Bluetooth network, infrared network, and other communication networks. While the example shown in FIG. 1 illustrates three computing devices 114, 116, and 118, in alternate implementations any number of computing devices may be present to access the application. There thus can be any number of visitors, even though the example shown in FIG. 1 illustrates only three visitors 108, 110 and 112.

The example provided above for the application displayed on the computing devices 114, 116 and 118 is a website. In one example, the website may have (e.g., be synced with) a variety of applications for mobile devices, such as applications being executed on different operating systems such as IOS, ANDROID, BLACKBERRY, SYMBIAN, WINDOWS, and/or the like. The website may be synced with those applications via a communication network, which can be one or more of: a local area network, a wide area network, a metropolitan area network, internet, intranet, Bluetooth network, infrared network, and other communication networks. In an alternate implementation, the application displayed on the computing devices 114, 116 and 118 can be the mobile application that is executed on operating systems such as IOS, ANDROID, BLACKBERRY, SYMBIAN, WINDOWS, and/or the like.

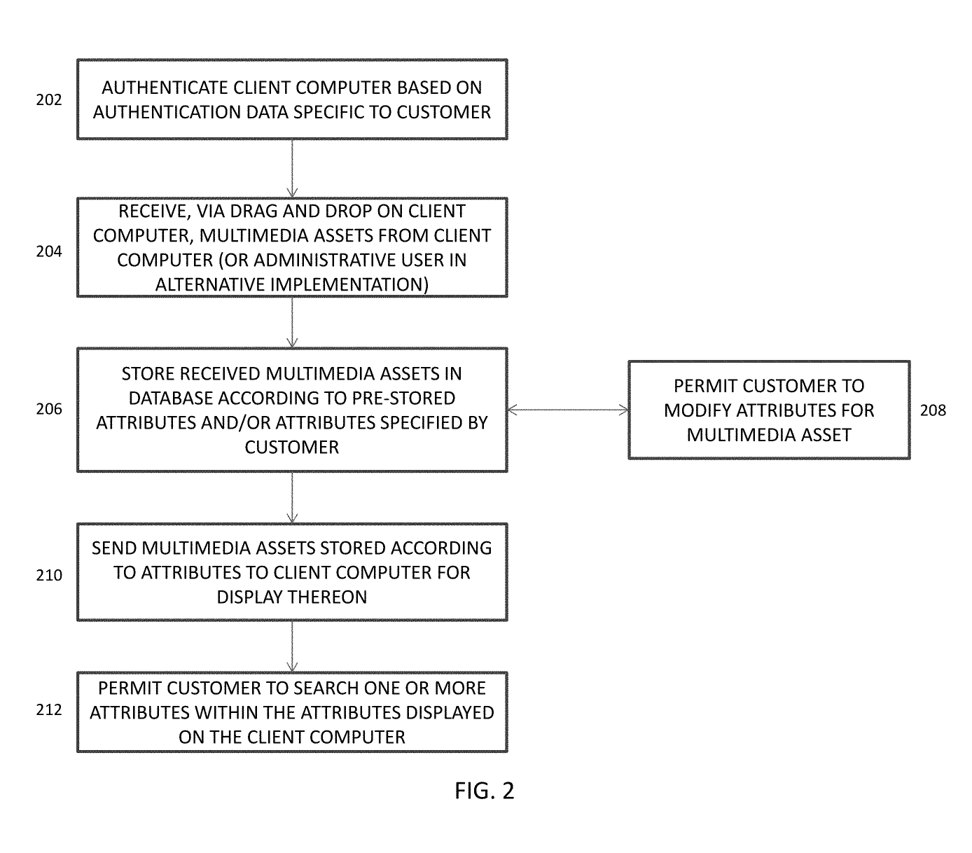

FIG. 2 illustrates storage of multimedia assets in one or more databases 130 of the computer server 104, tagging each stored multimedia asset with corresponding attributes, and enabling a search of the stored assets based on specific one or more attributes. The one or more processors 134 of the computing server 104 can authenticate, at 202, the client computer 106 based on authentication data input on the client computer 106 by the customer 107. In one example, the authentication data can be username and password. In an some implementations, the authentication data can be a personal identification number (PIN) of a smart card configured to be inserted into the client computer 106, a fingerprint, a voice pattern, a retinal scan, and/or any other type of authentication data.

The one or more processors 134 can receive, at 204, via a drag and drop on the client computer 106, multimedia assets from the client computer 106. In another implementation, the one or more processors 134 can alternately or additionally receive multimedia assets from the one or more servers 120, which is operated by the authorized user 122 of the application content host that controls the computing server 104. While drag and drop of multimedia assets is described here, in other implementations any other form of moving multimedia assets can be used such as copying and pasting techniques, or the like.

The one or more processors 134 can store, at 206, the received multimedia assets in the one or more databases 134 according to at least one of pre-stored attributes and new attributes specified on the client computer 106 by the customer 107. The one or more processors 134 can permit, at 208, the customer 107 to modify, on the client computer 106, the attributes for the stored multimedia assets. The one or more processors 134 can send, at 210, multimedia assets stored according to attributes to the client computer 106 for display thereon.

The one or more processors 134 can permit, at 212, the customer 107 to search, on the client computer 106, one or more attributes within the attributes displayed on the client computer 106. For example, the one or more processors 134 can allow the customer 107 to type in an identifier (e.g., name) of an attribute to search one or more multimedia assets tagged with that attribute. The one or more processors 134 can also allow the customer 107 to filter multimedia assets according to multimedia assets.

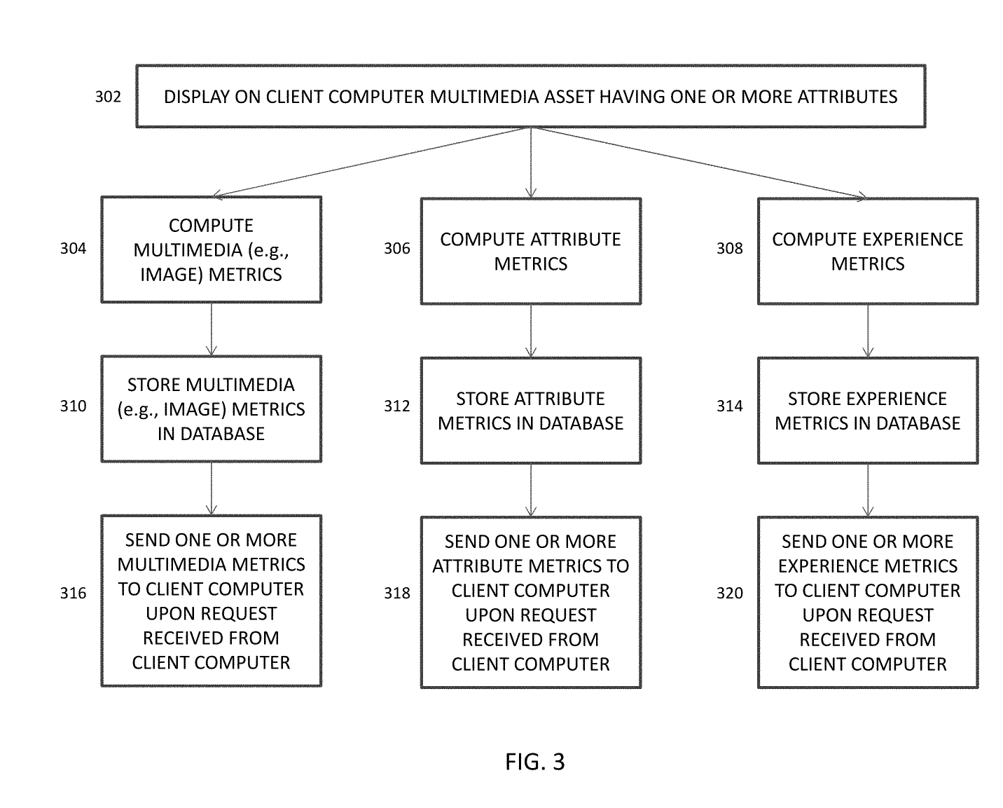

FIG. 3 illustrates storing multimedia assets, analyzing them with various metrics, and sending to a client computer 106 a selective portion of the analysis upon request for the same by the client computer 106. The one or more processors 134 can display, on client computer 106 at 302, at least a multimedia asset having one or more attributes. The one or more processors 134 can compute multimedia metrics such as image metrics, attribute metrics, and experience metrics at 304, 306, and 308, respectively.

The image metrics can include one or more of: size of image, location of image within an experience, number of actions associated with an image, conversion rate of an image, views of an image, number of clicks on an image, click rate on an image, any engagement metric that quantifies engagement of a user with the application, and the like. The attribute metrics can include one or more of: number of attributes, type of attributes used, conversion rate of multimedia assets with a particular attribute or a particular set of attributes, conversions on multimedia assets with a particular attribute or set of attributes, clicks of multimedia assets with a particular attribute or set of attributes, click rate of multimedia assets with a particular attribute or set of attributes, and the like.

The experience metrics can include one or more of: location of sub multimedia assets—that is, multimedia assets (for example, an image or an animation) that are a part of other multimedia assets (for example, a combination of an image and an animation); size such as at least one of height and width of a multimedia asset; location of a multimedia asset on the webpage; status (e.g., draft, staging, live, expired) of each multimedia asset or each combination of multiple multimedia assets associated with a particular multimedia asset—the status of each multimedia asset can be stored along with that multimedia asset in the one or more databases 134; other metrics such as views, clicks, click rate, conversions, conversion rate, any engagement metric that quantifies engagement of a user with the application, and the like; and any other one or more experience metrics.

The one or more processors 134 can store, in the one or more databases 134, multimedia metrics at 310, attribute metrics at 312, and experience metrics at 314. The one or more processors 134 can send, at 316, one or more multimedia metrics to client computer 106 upon request received for those one or more multimedia metrics from the client computer 106. The one or more processors 134 can send, at 318, one or more attribute metrics to client computer 106 upon request received for those one or more attribute metrics from the client computer 106. The one or more processors 134 can send, at 320, one or more experience metrics to client computer 106 upon request received for those one or more experience metrics from the client computer 106.

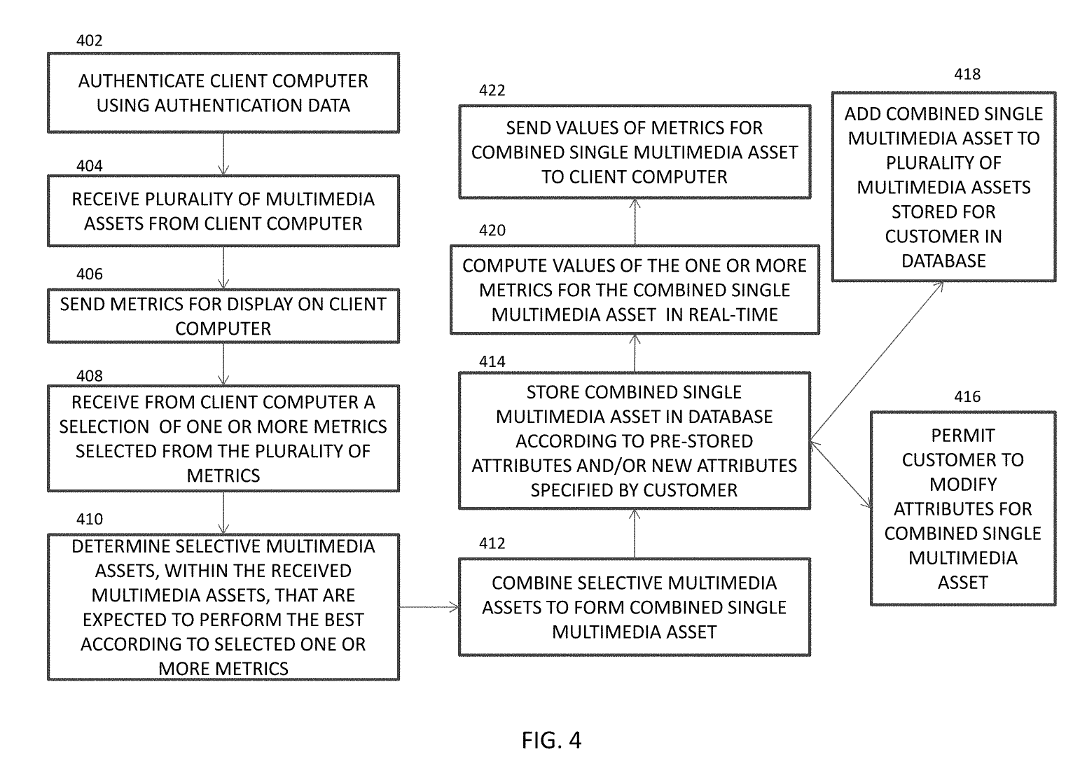

FIG. 4 illustrates creation, storage, and analysis of new multimedia assets in real-time. The new multimedia assets are more effective than previous multimedia assets, as the new multimedia assets increase interactivity and engagement of visitors 108, 110, and 112 on the application. The one or more processors 134 can authenticate, at 402, client computer 106 based on authentication data input on the client computer 106 by the customer 107. The one or more processors 134 can receive, at 404, multiple multimedia assets from the client computer 106. The one or more processors 134 can transmit, at 406, metrics to the client computer 106 for display on the client computer 106. The one or more processors 134 can receive, from client computer 106 at 408, a selection of one or more metrics, which the customer 107 has selected from the displayed metrics.

The one or more processors 134 can determine, at 410, selective multimedia assets, within the received multimedia assets, that are expected to perform the best according the selected one or more metrics. Such expectations can be computed using predictive models, which can use make predictions based on historical data by using predictive modeling technologies. The one or more processors 134 can combine, at 412, the selective multimedia assets to form a single combined multimedia asset. Such a combined single multimedia asset can be referred to as an experience.

The one or more processors 134 can store, at 414, the combined single multimedia asset in the one or more databases 134 according to at least one of pre-stored attributes and new attributes specified by the customer 107 on the client computer 106. The one or more processors 134 can permit, at 416, the customer 107 to modify attributes for the combined single multimedia asset. The one or more processors 134 can add, at 418, a single combined multimedia asset to a plurality of multimedia assets stored for the customer 107 in the one or more databases 134.

The processor can compute, at 420, values of the one or more metrics for the combined single multimedia asset in real-time. The processor can send, at 422, values of metrics for single combined multimedia asset to a client computer.

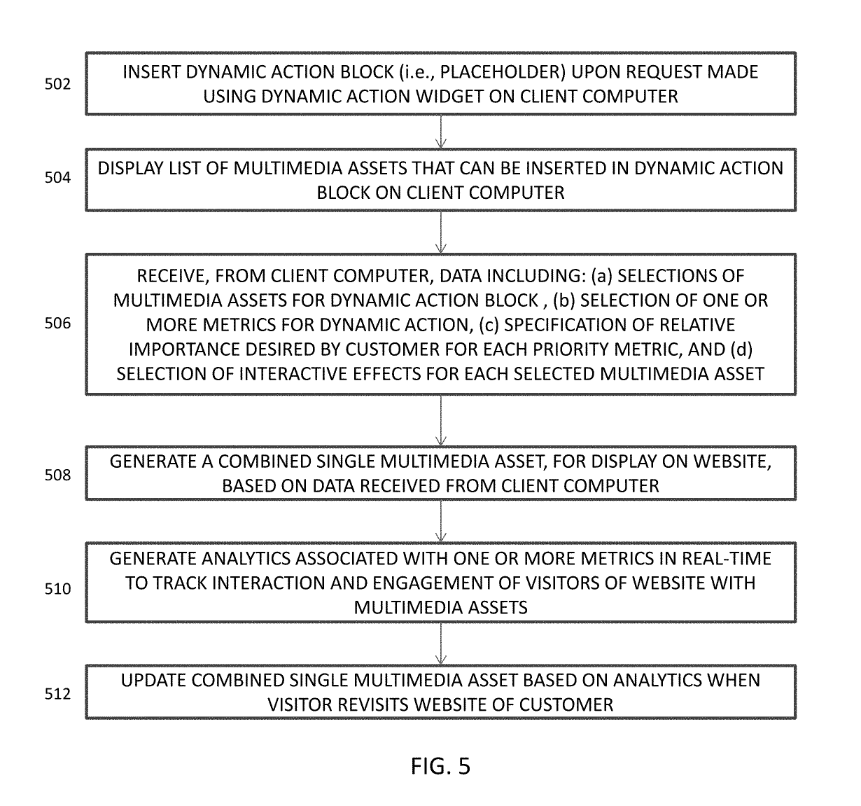

FIG. 5 illustrates a real-time population of an effective multimedia asset onto the application based on values of metrics and preferences specified by the customer 107 on the client computer 106. The one or more processors 134 can insert, at 502, a dynamic action block (e.g., a placeholder) into the application upon a request made using a dynamic action widget (e.g., a button or link on the application) on the client computer 106. The one or more processors 134 can display, on client computer 106 at 504, a list of multimedia assets that can be inserted in the dynamic action block on the application.

The one or more processors 134 can receive, from the client computer 106 at 506, data including: (a) selections of multimedia assets for dynamic action block, (b) selection of one or more metrics desired by the customer 107 to analyze dynamic action, (c) specification of relative importance desired by customer 107 for each priority metric, and (d) selection of interactive effects for each selected multimedia asset. The one or more processors 134 can generate, at 508, a single combined multimedia asset, for display on the application, based on the data received from client computer.

The one or more processors 134 can generate, at 510, analytics associated with one or more metrics in real-time to track interaction and engagement of visitors 108, 110 and 112 with multimedia assets of the website. The one or more processors 134 can update, at 512, the combined single multimedia asset based on the analytics (i.e., values of the metrics) when visitor 108, 110 or 112 revisits the application of the customer 107.

Various implementations of the subject matter described herein can be realized/implemented in digital electronic circuitry, integrated circuitry, specially designed application specific integrated circuits (ASICs), computer hardware, firmware, software, and/or combinations thereof. These various implementations can be implemented in one or more computer programs. These computer programs can be executable and/or interpreted on a programmable system. The programmable system can include at least one programmable processor, which can have a special purpose or a general purpose. The at least one programmable processor can be coupled to a storage system, at least one input device, and at least one output device. The at least one programmable processor can receive data and instructions from, and can transmit data and instructions to, the storage system, the at least one input device, and the at least one output device.

These computer programs (also known as programs, software, software applications or code) can include machine instructions for a programmable processor, and can be implemented in a high-level procedural and/or object-oriented programming language, and/or in assembly/machine language. As can be used herein, the term “machine-readable medium” can refer to any computer program product, apparatus and/or device (for example, magnetic discs, optical disks, memory, programmable logic devices (PLDs)) used to provide machine instructions and/or data to a programmable processor, including a machine-readable medium that can receive machine instructions as a machine-readable signal. The term “machine-readable signal” can refer to any signal used to provide machine instructions and/or data to a programmable processor.

To provide for interaction with a user, the subject matter described herein can be implemented on a computer that can display data to one or more users on a display device, such as a cathode ray tube (CRT) device, a liquid crystal display (LCD) monitor, a light emitting diode (LED) monitor, or any other display device. The computer can receive data from the one or more users via a keyboard, a touchscreen, a mouse, a trackball, a joystick, or any other input device. To provide for interaction with the user, other devices can also be provided, such as devices operating based on user feedback, which can include sensory feedback, such as visual feedback, auditory feedback, tactile feedback, and any other feedback. The input from the user can be received in any form, such as acoustic input, speech input, tactile input, or any other input.

The subject matter described herein can be implemented in a computing system that can include at least one of a back-end component, a middleware component, a front-end component, and one or more combinations thereof. The back-end component can be a data server. The middleware component can be an application server. The front-end component can be a client computer having a graphical user interface or a web browser, through which a user can interact with an implementation of the subject matter described herein. The components of the system can be interconnected by any form or medium of digital data communication, such as a communication network. Examples of communication networks can include a local area network, a wide area network, internet, intranet, Bluetooth network, infrared network, or other networks.

The computing system can include clients and servers. A client and server can be generally remote from each other and can interact through a communication network. The relationship of client and server can arise by virtue of computer programs running on the respective computers and having a client-server relationship with each other.

Although a few variations have been described in detail above, other modifications can be possible. For example, the logic flows depicted in the accompanying figures and described herein do not require the particular order shown, or sequential order, to achieve desirable results. Other implementations or embodiments may be within the scope of the following claims.

What is claimed is:

1. A method comprising:
transmitting, by a computing server to a client computer, data to execute a computer program that interacts with a customer authorized to use the client computer to create one or more multimedia assets;
receiving, by the computing server and from the client computer, the one or more multimedia assets;
publishing, by the computing server and based on at least one attribute of the one or more multimedia assets, the one or more multimedia assets on an application executed on one or more computing devices communicatively coupled to the computing server;
analyzing, by the computing server, one or more interactions between the one or more computing devices and the one or more published multimedia assets and between the one or more computing devices and the at least one attribute of the one or more published multimedia assets to generate an analysis; and
modifying, by the computing server, the one or more published multimedia assets in the application based on at least one of the analysis and one or more preferences of the customer.

2. The method of claim 1, wherein the one or more multimedia assets comprise at least one of an image, a video, an action-based icon, and text.

3. The method of claim 2, wherein the at least one attribute of the one or more multimedia assets comprises one or more of: an identification of a multimedia asset of the one or more multimedia assets, a type of animation in the multimedia asset, a number of images in the multimedia asset, a page size of the multimedia asset, a font type for the multimedia asset, a font size for the multimedia asset, and a font color for the multimedia asset.

4. The method of claim 3, wherein the type of animation includes one or more of: a hover-over effect associated with multimedia asset, a fade-in effect associated with multimedia asset, a transparency change associated with multimedia asset, and an image enlargement associated with multimedia asset.

5. The method of claim 1, wherein the application executed on one or more computing devices is communicatively coupled to the computing server via a content delivery network comprising one or more proxy servers.

6. The method of claim 1, wherein the analysis comprises one or more of: an image metric associated with a multimedia asset of the one or more multimedia assets, an attribute metric associated with the multimedia asset, and an experience metric associated with the multimedia asset.

7. The method of claim 1, wherein the publishing of the multimedia assets on the application comprises:
overlaying the multimedia assets on the application.

8. The method of claim 1, further comprising:
storing, by the computing server, the multimedia assets received from the client computer.

9. The method of claim 1, wherein the application is a website.

10. The method of claim 1, wherein the one or more computing devices are configured to be operated by one or more visitors of the application.

11. The method of claim 1, wherein the modifying of the one or more published multimedia assets in the application occurs in real-time.

12. A system comprising:
a user interface module to provide a computer program to a client computer;
an application programming interface to receive an identification of one or more multimedia assets and one or more customer preferences from the client computer; and
a web module to transmit the one or more multimedia assets to a content delivery network for publication in an application implemented on a computing device, the content delivery network configured to be communicatively coupled to the web module and the computing device.

13. The system of claim 12, further comprising:
a database to receive the one or more multimedia assets from the web module, the database configured to store the received one or more multimedia assets.

14. The system of claim 12, further comprising:
a controller operably coupled to the user interface module, the application programming interface, and the web module.

15. The system of claim 12, wherein the web module is configured to receive the identification of one or more multimedia assets and the one or more customer preferences from the application programming interface.

16. A non-transitory machine-readable medium storing instructions that, when executed by at least one programmable processor, cause the at least one programmable processor to perform operations comprising:
transmitting, to a client computer, data to execute a program that enables a customer authorized to use the client computer to create one or more multimedia assets;
receiving, from the client computer, the one or more multimedia assets;
publishing, based on at least one attribute of the one or more multimedia assets, the one or more multimedia assets on an application executed on one or more computing devices coupled to the computing server;
analyzing one or more interactions between the one or more computing devices and the one or more published multimedia assets and between the one or more computing devices and the at least one attribute of the one or more published multimedia assets to generate an analysis; and
modifying the one or more published multimedia assets in the application based on the analysis.

17. The non-transitory machine-readable medium of claim 16, wherein the publishing of the multimedia assets on the application comprises:
overlaying the multimedia assets on the application.

18. The non-transitory machine-readable medium of claim 16, wherein the operations further comprise:
storing, by the computing server, the multimedia assets received from the client computer.

19. The non-transitory machine-readable medium of claim 16, wherein:
the application is a website; and
the one or more computing devices are configured to be operated by one or more visitors of the website.

20. The non-transitory machine-readable medium of claim 16, wherein the modifying of the one or more published multimedia assets in the application occurs in real-time.
